(19) United States
(12) Patent Application Publication
(10) Pub. No.: US 2022/0354145 A1
(43) Pub. Date: Nov. 10, 2022

(54) Soluble Tea Extract Tablet and Method of Preperation

(71) Applicant: Shlomo Matan Avshalom, Adi (IL)

(72) Inventor: Shlomo Matan Avshalom, Adi (IL)

(21) Appl. No.: 17/315,386

(22) Filed: May 10, 2021

(51) Int. Cl. A23F 3/32; A23F 3/14; A23L 33/105; A23L 33/125; A23L 29/00; A23L 29/30; A23L 27/30; A23L 29/25

(52) U.S. Cl. CPC A23F 3/32; A23F 3/14; A23L 33/105; A23L 33/125; A23L 29/035; A23L 29/30; A23L 27/34; A23L 29/25

(57) ABSTRACT

A sugar-free soluble tea extract tablet and a method for preparing it that includes the steps of providing a sweetener blend, a natural binder, and a tea extract, in a proportion of five grams of sweater blend and one gram of natural binder for every one gram of tea extract. Then, heating the sweetener blend to melt into a liquid at a temperature ranged between 100 to 300 degrees Celsius, adding the tea extract and the natural binder to the melted sweetener blend to form a mixture, stirring the mixture thoroughly and pouring it into molds for cooling. The sweetener blend includes Erythritol and Monkfruit or stevia sweetener, and the natural binder is an organic gum fiber blend such as organic guar gum, organic gum arabic, organic agave fiber, organic rice hulls, or organic agave syrup.

### TECHNICAL FIELD

The present invention refers to a soluble tae extract tablets and a method for preparations these sugar-free tea extract tablets.

### BACKGROUND ART

Drinking tea is a common daily practice around the world. It is customary to consume tea packed in tea bags or tea leaves of various sizes, sometimes rolled and cut. The present invention discloses a sugar-free soluble tea extract tablet and a method of preparation these tea tablets. U.S. Pat. No. 1,520,122 discloses a solid water soluble tea tablets based on sugar and in a different process of preparation. On the other hand, the present invention discloses a sugar-free soluble tae extract tablets and a new and non-obvious process for preparations of these tablets.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the soluble tea extract tablets (1).

FIG. 2 depicts the sweetener blend (2), the natural binder (3), and the tea extract (4).

FIG. 3 depicts the soluble tea extract tablet (10).

FIG. 4 depicts the sucrose (11), the fructose (12), the tapioca syrup (13), and the tea extract (4).

### THE INVENTION

The main object of the present invention is to provide a sugar-free soluble tea extract tablet (1) and a method for preparations this tablet. The sugar-free soluble tea extract tablet (1) consists of a homogenous mixture of a sweetener blend (2), a natural binder (3), and a tea extracts (4), in a proportion of five grams of said sweater blend and one gram of said natural binder for every one gram of said tea extract. The user can put one or more of said sugar-free soluble tea extract tablets into a cup with hot water for making a cup of tea. The tablet (1) may also include Cannabidiol (CBD) that is extracted from cannabis plants.

The method of preparation of the sugar-free soluble tea extract tablets (1) includes the use of the equipment and materials and understood from the following steps:

First step: providing a sweetener blend, a natural binder, and a tea extract, in a proportion of five grams of the sweater blend and one gram of the natural binder for every one gram of the tea extract.

The sweetener blend includes Erythritol plus Monkfruit sweetener or stevia sweetener. Erythritol is a chemical compound, used as a food additive and sugar substitute, it is naturally occurring and is made from corn. Erythritol is sweet almost as sucrose (table sugar), yet it is almost noncaloric and does not affect blood sugar or cause tooth decay. Monk fruit sweetener that is also known as Siraitia grosvenorii is extracted from monk fruit. Stevia is a sweetener and sugar substitute derived from the leaves of the plant species Stevia rebaudiana. The erythritol may be added separately from the monkfruit, and possible to use other high intensity sweeteners could be used such as stevia. The natural binder may be an organic gum fiber blend such as organic guar gum, organic gum arabic, organic agave fiber, organic rice hulls, or organic agave syrup.

Second step: heating the sweetener blend to melt into a liquid at a temperature ranged between 100 to 300 degrees Celsius. The liquid may be water.

Third step: adding the tea extract and the natural binder to the melted sweetener blend to form a mixture, stirring the mixture thoroughly and pouring the mixture into molds for cooling. It is also possible to add Cannabidiol (CBD).

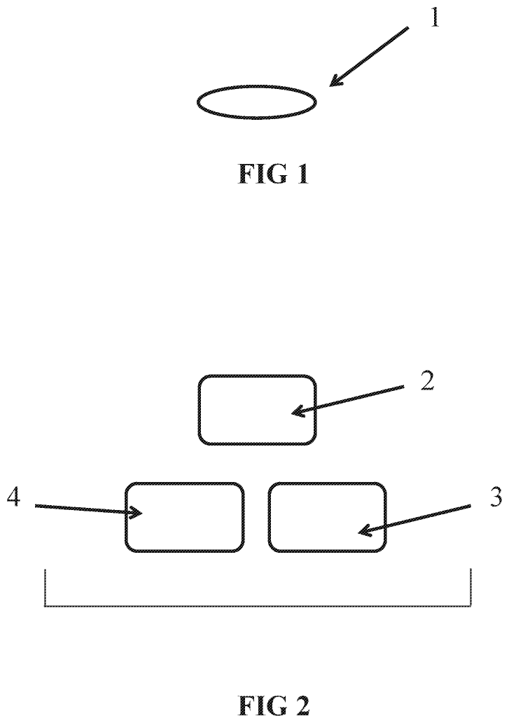

The user can put one, two or few soluble tea extract tablets into a cup with hot water for making a cup of tea. It is possible to sell a package of several soluble tea extract tablets in different flavors and different degree of sugar. FIG. 1 depicts the sugar-free soluble tea extract tablet (1) and FIG. 2 depicts the sweetener blend (2), the natural binder (3), and the tea extract (4).

Another object of the present invention is to provide a soluble tea extract tablet (10) and a method for preparations this tablet. The method for preparing the soluble tea extract tablet (10), comprising the steps of: (a) providing sucrose (sugar), fructose (fruit sugar), tapioca syrup, and tea extract, in a proportion of half gram of said sucrose, two grams of said fructose, four and half grams of said tapioca syrup for every one gram of said tea extract; (b) heating the sucrose the fructose and the tapioca syrup with liquids at a temperature ranged between 100 to 200 degrees Celsius to form a mixture; (c) adding the tea extract to the mixture, stirring the mixture thoroughly and pouring the mixture into molds for cooling. It is also possible to add Cannabidiol (CBD).

The soluble tea extract tablet (10) consists of homogenous mixture of sucrose (11), fructose (12), tapioca syrup (13), and tea extract (4), in a proportion of half gram of said sucrose, two grams of said fructose, four and half grams of said tapioca syrup for every one gram of said tea extract; whereby enabling a user to put one or more of said sugar-free soluble tea extract tablets into a cup with hot water for making a cup of tea. The tablet (10) may also include Cannabidiol (CBD).

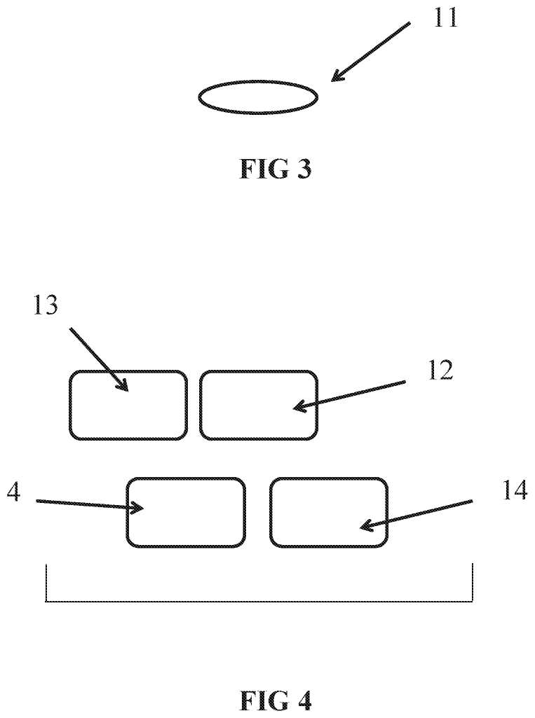

FIG. 3 depicts the soluble tea extract tablet (10) and FIG. 4 depicts the sucrose (11), the fructose (12), the tapioca syrup (13), and the tea extract (4).

What is claimed is:

1. A method for preparing a sugar-free soluble tea extract tablet, comprising the steps of:
(a) providing a sweetener blend, a natural binder, and a tea extract, in a proportion of five grams of said sweater blend and one gram of said natural binder for every one gram of said tea extract;
(b) heating the sweetener blend to melt into a liquid at a temperature ranged between 100 to 300 degrees Celsius;
(c) adding the tea extract and the natural binder to the melted sweetener blend to form a mixture, stirring the mixture thoroughly and pouring the mixture into molds for cooling.

2. The method of claim 1, wherein said sweetener blend includes Erythritol and Monkfruit or stevia sweetener, and wherein said natural binder is an organic gum fiber blend such as organic guar gum, organic gum arabic, organic agave fiber, organic rice hulls, or organic agave syrup.

3. The method of claim 1, wherein further adding cannabidiol to said mixture.

4. A sugar-free soluble tea extract tablet that consists of homogenous mixture of a sweetener blend, a natural binder, and a tea extracts, in a proportion of five grams of said sweater blend and one gram of said natural binder for every one gram of said tea extract; whereby enabling a user to put one or more of said sugar-free soluble tea extract tablets into a cup with hot water for making a cup of tea.

5. The sugar-free soluble tea extract tablet according to claim 4 that further includes cannabidiol.

6. A method for preparing a soluble tea extract tablet, comprising the steps of:
(a) providing sucrose, fructose, tapioca syrup, and tea extract, in a proportion of half gram of said sucrose, two grams of said fructose, four and half grams of said tapioca syrup for every one gram of said tea extract;
(b) heating the sucrose the fructose and the tapioca syrup with liquids at a temperature ranged between 100 to 200 degrees Celsius to form a mixture;
(c) adding the tea extract to the mixture, stirring the mixture thoroughly and pouring the mixture into molds for cooling.

7. The method of claim 6, wherein further adding cannabidiol to said mixture.

8. A soluble tea extract tablet that consists of homogenous mixture of sucrose, fructose, tapioca syrup, and tea extract, in a proportion of half gram of said sucrose, two grams of said fructose, four and half grams of said tapioca syrup for every one gram of said tea extract; whereby enabling a user to put one or more of said sugar-free soluble tea extract tablets into a cup with hot water for making a cup of tea.
